(19) United States
(12) Patent Application Publication
(10) Pub. No.: US 2006/0215307 A1
(43) Pub. Date: Sep. 28, 2006

(54) Storage apparatus, control method and program

(75) Inventors: Osamu Yoshida, Kawasaki (JP); Masaaki Motoki, Kawasaki (JP); Takumi Kakuya, Kawasaki (JP); Masakazu Tsuruoka, Kawasaki (JP); Goichi Kashiwagi, Kawasaki (JP); Masaki Obuchi, Kawasaki (JP); Shunsuke Aoki, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/182,240

(22) Filed: Jul. 15, 2005

(30) Foreign Application Priority Data
Mar. 25, 2005 (JP) 2005-088147

(51) Int. Cl. G11B 21/02

(52) U.S. Cl. 360/75

(57) ABSTRACT

The write cache control unit stores data in the buffer memory in response to a write command from a higher-level apparatus to respond a normal ending of the command, and then writes the data in the buffer memory on the disk medium. The vibratory environment measuring unit measures an environment under which a vibration is applied to the apparatus. When an abnormal vibratory environment under which writing on the disk medium likely fails is determined from a measured environment by the vibratory environment measuring unit, the vibration countermeasure processing unit disables the write cache control unit, and if the write cache data remains in the buffer memory at that time, writes the data in the temporary storage area, and if the abnormal vibratory environment is not determined, writes back the data to the original position on the disk medium.

This application is a priority based on prior application No.JP 2005-088147, filed Mar. 25, 2005, in Japan.

### BACKGROUND OF THE INVENTION

1. Field of the Invention

The present invention relates to a storage apparatus, a control method and a program for determining an abnormal vibration and avoiding a write fault error for a disk medium, and particularly to a storage apparatus, a control method and a program for controlling a write cache function in response to a write command from a higher-level apparatus and avoiding a write fault error due to an abnormal vibration.

2. Description of the Related Arts

In recent years, a magnetic disk apparatus has been widely used and is used in a vehicle-mounted apparatus such as car navigation system and a home appliance such as DVD recorder. Further, the magnetic disk apparatus has been made smaller so that a track itself recording therein data is made finer and a track interval is made narrower. In such a situation, it is assumed that a magnetic disk apparatus is placed under an environment influenced by vibrations, and it is an important object how to hold data under such an environment. In a conventional magnetic disk apparatus, a head reads and demodulates servo information written on a medium to detect a deviation between the head and a track center, and performs track following control (on-track control) such that the head is positioned on the center of the track. The head is supported relative to a medium recording face by a rotary actuator which is driven by a voice coil motor, and if it is vibrated when a vibration above a certain level is applied from the outside, the deviation amount of the head increases while the head is performing the track following control. When a vibration applied to the apparatus in such a situation increases more, the deviation amount of the head exceeds an allowable limit so that data writing on the medium may fail as a write fault error. In such a conventional magnetic disk apparatus, when a write fault error occurs, a certain number of retries are repeated, and when error recovery is still impossible, it is considered as a medium fault to perform an alternating processing. However, when a vibration is a factor of the write fault error, it is expected that writing failure occurs also in the case of writing into an alternating destination or writing into a system area of alternating management information storing therein information required for performing the alternating processing. Consequently, when data cannot be finally written, there is no means for storing the data so that the data is finally lost. On the other hand, the magnetic disk apparatus normally uses the write cache function as being enable. When the write cache function receives a write command from the higher-level apparatus, it responds the normal ending of the command to the higher-level apparatus in the state where write data is written into a buffer, and thereafter writes the write data in the buffer on a medium. This write cache function is used to improve access performance of the higher-level apparatus.

[Patent Reference] Japanese Patent Application Laid-Open No. 2002-74934 Publication

[Patent Reference] Japanese Patent Application Laid-Open No. 2001-14783 Publication

However, in such a conventional magnetic disk apparatus, when the data is finally lost due to a write fault error caused by a vibration in the state where the write cache function is used, since the write command from the higher-level apparatus has been normally terminated, the error report cannot be performed so that the higher-level apparatus cannot perform retry processing for the error ending. In other words, neither the higher-level apparatus nor the magnetic disk apparatus can recover the error and there is always a concern that data would be lost. When data is lost, a timing of the error report delays in the conventional magnetic disk apparatus, but the error ending is notified to the command received from the higher-level apparatus after the final failure of the writing, and then the write cache function is prohibited or a write request itself is prohibited. On the other hand, though some of the conventional magnetic disk apparatuses prohibit the writing operation when detecting an abnormal vibration by a sensor or the like, since a positional deviation due to a vibration of the head is not determined, the writing operation may be prohibited even due to a vibration which would not cause a write fault error, and since an input/output processing of the higher-level apparatus is completely prohibited during the vibration, the function of the magnetic disk apparatus is temporarily lost, and there is a problem that the processing performance is remarkably deteriorated under a vibration sensitive environment. According to the present invention to provide a storage apparatus, a control method and a program for accurately avoiding an error causing data loss even under an abnormal vibration, thereby improving reliability of data storing.

### SUMMARY OF THE INVENTION

The present invention provides a storage apparatus. In other words, the present invention is characterized by a storage apparatus for writing data on a storage medium based on a write command from a higher-level apparatus, which comprises a write cache control unit for storing data in a buffer memory in response to a write command from the higher-level apparatus to respond a normal ending of the command, and then writing the data in the buffer memory on the storage medium, a vibratory environment measuring unit for measuring a vibratory environment of the apparatus, and a vibration countermeasure processing unit for, when an abnormal vibratory environment under which writing into the storage medium likely fails is determined from a measured vibratory environment by the vibratory environment measuring unit, disabling the write cache control unit.

After the write cache control unit is disabled, the vibration countermeasure processing unit releases the disabling of the write cache control unit when the abnormal vibratory environment cannot be determined.

The vibratory environment measuring unit records a comparison result between a predetermined threshold value and the deviation amount of a head position relative to a track center position detected during track following control of the head based on servo information on the storage medium, and when the number of times at which the head deviation amount recorded by the vibratory environment measuring unit exceeds the threshold value is the predetermined number of times or more per rotation and continues for several rotations, the vibration countermeasure processing unit determines an abnormal vibratory environment and disables the write cache control unit, and releases the disabling of the write cache control unit 46 when the number of times at which the head deviation amount recorded by the vibratory environment measuring unit exceeds the threshold value does not exceed the predetermined threshold value per rotation after the write cache control unit is disabled.

When the write cache control unit is disable, if write data to be written back into the disk apparatus remains in the buffer memory, the vibration countermeasure processing unit stores the write data in a temporary storage area, and writes back the data stored in the temporary storage area on the storage medium in the state where the disabling of the write cache control unit is being released.

When wiring data into the system area on the storage medium, the vibration countermeasure processing unit stores the data in the temporary storage area if an abnormal vibratory environment is determined, and writes back the data into the system area on the storage medium from the temporary storage area after the abnormal vibratory environment is not determined.

The temporary storage area is provided on the storage medium and the temporary storage area on the storage medium has a larger track width for a normal storage area. The temporary storage area may be provided in a nonvolatile memory in the storage apparatus.

The present invention provides a method for controlling a storage apparatus. In other words, the present invention is characterized by a method for controlling a storage apparatus for writing data on a storage medium based on a write command from a higher-level apparatus, comprising:

a write cache control step for storing data in a buffer in response to a write command from the higher-level apparatus to respond a normal ending of the command, and then writing the data in the buffer on the storage medium;

a vibratory environment measuring step for measuring a vibratory environment of the apparatus; and

a vibration countermeasure processing step for, when an abnormal vibratory environment under which writing on the storage medium likely fails is determined from a measured vibratory environment by the vibratory environment measuring step, disabling the write cache control step.

The present invention provides a program executed by a computer of a storage apparatus. In other words, the program according to the present invention is characterized by causing a computer in a storage apparatus for writing data on a storage medium based on a write command from a higher-level apparatus to execute:

a write cache control step for storing data in a buffer in response to a write command from the higher-level apparatus to respond a normal ending of the command, and then writing the data in the buffer on the storage medium;

a vibratory environment measuring step for measuring a vibratory environment of the apparatus; and

a vibration countermeasure processing step for, when an abnormal vibratory environment under which writing on the storage medium likely fails is determined from a measured vibratory environment by the vibratory environment measuring step, disabling the write cache control step.

Details of the control method and the program according to the present invention are basically identical to those of the storage apparatus according to the present invention.

According to the present invention, when an abnormal vibratory environment is determined from the deviation amount of the head following-controlled relative to the track center, the disabling is performed so as not to perform write cache control, so that when the writing fails due to an abnormal vibration in response to a write command from the higher-level apparatus, an error can be notified and a normal writing operation at a timing at which the abnormal vibration is eliminated can be expected by the retry from the higher-level apparatus. Further, the write cache data already received in the buffer from the higher-level apparatus prior to the disabling so as not to perform the write cache control is written in the temporary storage area where the track width of the storage medium is increased or in the nonvolatile memory in the apparatus even under the abnormal vibratory environment, and is written back on the storage medium after the abnormal vibratory environment is eliminated, so that the user data can be guaranteed, thereby accurately avoiding final data loss due to an error. When an abnormal vibratory environment is determined, the control information in the storage apparatus to be written in the system area on the storage medium is written in the temporary storage area where the track width of the storage medium is widened or in the nonvolatile memory in the apparatus, and is written back to the system area on the storage medium after the abnormal vibratory environment is eliminated so that the system information can be accurately updated, thereby improving the reliability of the storage apparatus against the vibration and reducing failures of devices used in the storage apparatus. The above and other objects, features, and advantages of the present invention will become more apparent from the following detailed description with reference to the drawings.

### BRIEF DESCRIPTION OF THE DRAWINGS

FIG. 1 is a block diagram of a magnetic disk apparatus according to the present invention to which a countermeasure against an abnormal vibratory environment is applied;

FIG. 2 is an explanatory diagram of a track format in a disk medium of FIG. 1;

FIG. 3 is an explanatory diagram of a measurement table of a head positional deviation amount stored in a memory of FIG. 1;

FIG. 4 is an explanatory diagram of a layout of a temporary storage area according to the present invention;

FIG. 5 is an explanatory diagram of track sizes of a user area and a temporary storage area in a disk medium of FIG. 4;

FIG. 6 is a flowchart of a measurement of an abnormal vibratory environment and a determining processing according to the present invention;

FIGS. 7A and 7B are flowcharts of a control processing of the magnetic disk apparatus according to the present invention;

FIG. 8 is a flowchart of a write command processing according to the present invention; and

FIG. 9 is a flowchart of a system information write processing according to the present invention.

### DETAILED DESCRIPTION OF THE PREFERRED EMBODIMENTS

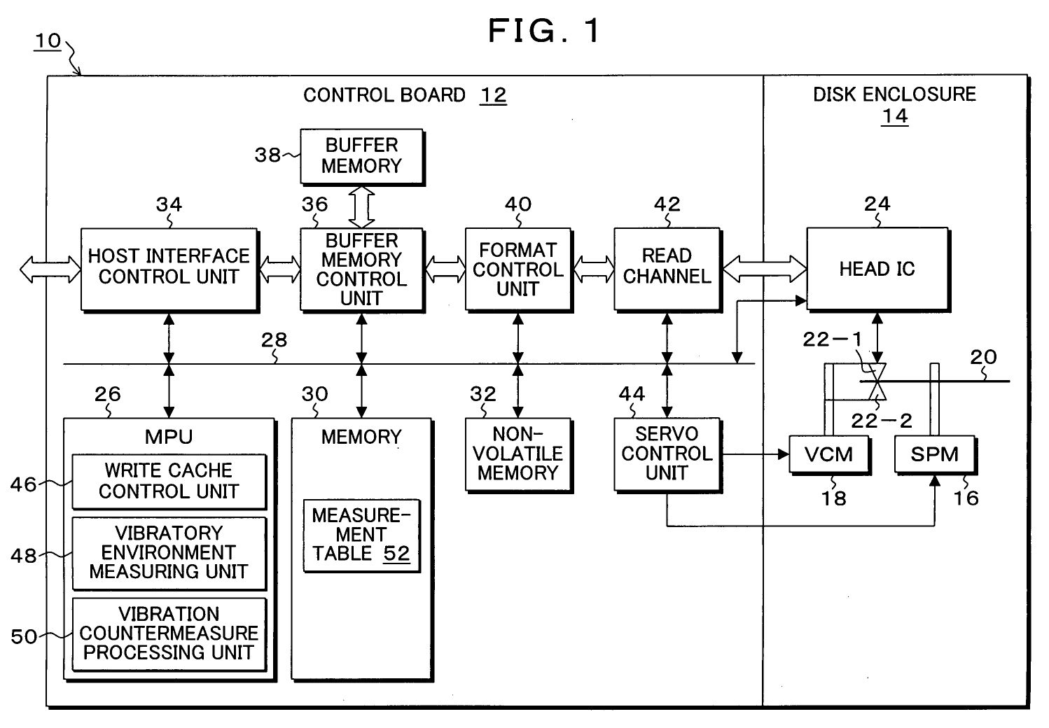

FIG. 1 is a block diagram of a magnetic disk apparatus to which the present invention is applied, which comprises a vibration countermeasure function corresponding to use situation where a write fault error may possibly occur due to an external vibration. In FIG. 1, a magnetic disk apparatus 10 known as a hard disk drive (HDD) is constituted of a disk enclosure 14 and a control board 12. The disk enclosure 14 is provided with a spindle motor 16, and a disk medium (storage medium) 20 is mounted on a rotation shaft of the spindle motor 16 and is rotated for a certain time, for example, at 4200 rpm. The disk enclosure 14 is provided with a voice coil motor 18, and the voice coil motor 18 mounts heads 22-1 and 22-2 on a tip of an arm of a head actuator to position the head relative to a recording face of the disk medium 20. A write head and a read head are integrally mounted on the heads 22-1 and 22-2. The heads 22-1 and 22-2 are connected to a head IC 24 through a signal line, and the head IC 24 selects one head by a head select signal based on a write command or read command from a host as a higher-level apparatus to perform writing or reading. Further, the head IC 24 is provided with a write amplifier for write system and a preamplifier for read system. The control board 12 is provided with a MPU 26, and a bus 28 of the MPU 26 is provided with a memory 30 for storing therein a control program and control data using a RAM and a nonvolatile memory 32 for storing therein a control program using a FROM or the like. The bus 28 of the MPU 26 is provided with a host interface control unit 34, a buffer memory control unit 36 for controlling a buffer memory 38, a format control unit 40 functioning as a hard disk controller, a read channel 42 functioning as a write modulating unit and a read demodulating unit, and a servo control unit 44 for controlling the voice coil motor 18 and the spindle motor 16. The magnetic disk apparatus 10 performs writing processing and reading processing based on commands from the host. Here, the normal operation in the magnetic disk apparatus will be explained as follows. When the host interface control unit 34 receives a write command and write data from the host, it decrypts the write command in the MPU 26 and stores the received write data in the buffer memory 38 as needed, and thereafter converts it to a predetermined data format in the format control unit 40, adds an ECC code by the ECC processing, and performs scrambling, RLL code converting and write compensating in the write modulating system in the read channel 42, and then writes it on the disk medium 20, for example, from the write head of the head 22-1 selected through the head IC 24 from the write amplifier. At this time, a head positioning signal is given to the servo control unit 44 using DSP or the like from the MPU 26, and the voice coil motor 18 seeks the head to a target track instructed by the command to perform on-track and track following control. On the other hand, when the host interface control unit 34 receives a read command from the host, it decrypts the read command in the MPU 26 and amplifies a read signal read out from the read head selected by the head select of the head IC 24 by the read amplifier, and then inputs it in the read demodulating system of the read channel 42 and demodulates the read data by partial response maximum likelihood detection (PRML) or the like to detect and correct an error by performing the ECC processing in the format control unit 40, and thereafter buffers it to the buffer memory 38 and transfers the read data from the host interface control unit 34 to the host. The MPU 26 is provided with a write cache control unit 46, a vibratory environment measuring unit 48 and a vibration countermeasure processing unit 50 as functions realized by execution of the programs. The write cache control unit 46 stores the write data in the buffer memory 38 by the buffer memory control unit 36 to respond a normal ending of the command in response to the write command from the host, and then writes the write data in the buffer memory 38 in a target sector on the disk medium 20 via the format control unit 40, the read channel 42 and the head IC 24. The function of this write cache control unit 46 can designate to be enabled or disabled from the host. The vibratory environment measuring unit 48 measures a vibratory environment of the magnetic disk apparatus 10. The vibratory environment measuring unit 48 records a comparison result between a predetermined threshold value and the deviation amount of the head position relative to the track center position detected during the track following control (on-track control) of the head 22-1 or 22-2 presently selected by the head IC 24 as a measurement result in a measurement table 52 of the memory 30 per rotation of the disk medium.

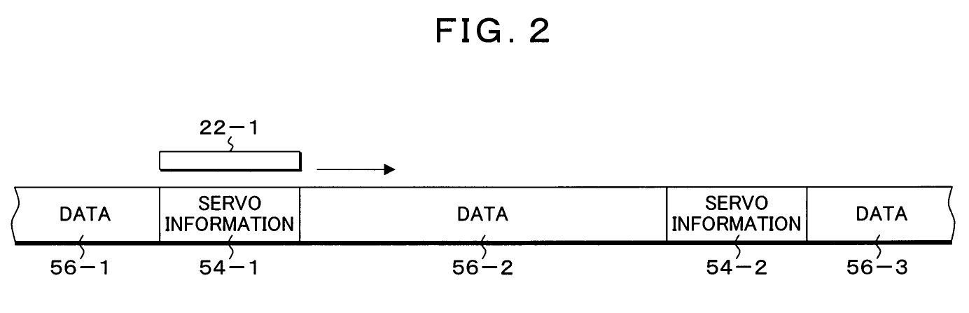

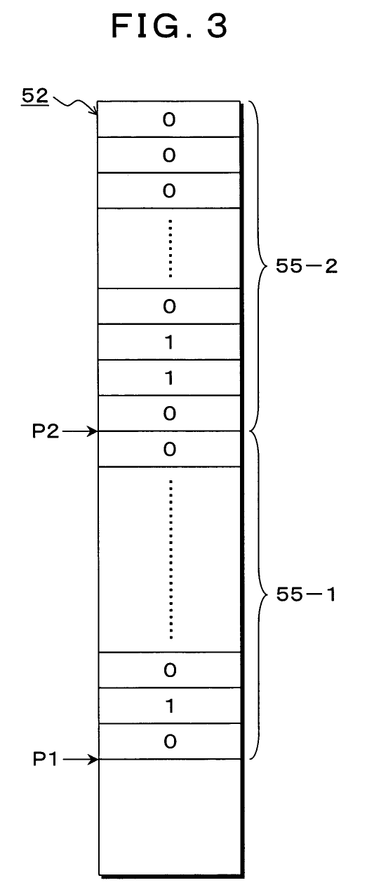

FIG. 2 shows that one track of the recording face of the disk medium 20 provided in the magnetic disk apparatus 10 is taken out and servo areas 54-1, 54-2, . . . , 54-n (not shown) recording therein servo information are recorded on the track in the circumference direction at a constant interval. Data areas 56-1, 56-2, . . . , 56-n are present between the servo areas 54-1, 54-2, . . . , 54-n (not shown), and each is divided into a plurality of sectors. The servo area 54-1, 54-2, . . . , 54-n (not shown) records therein servo position information (burst) for detecting the positional deviation amount relative to the track center of, for example, the head 22-1, and this servo area 54-1 is read by the read head of the head 22-1 and demodulated by the read channel 52 in FIG. 1 so that the positional deviation amount of the head relative to the track center can be detected. Each time the positional deviation amount of the head is detected based on the reading of the servo area 54-1 to 54-n (not shown) in FIG. 2, the servo control unit 44 shown in FIG. 1 controls the voice coil motor 18 such that the deviation amount is zero, and performs feedback control for causing the head 22-1 to follow the track. The vibratory environment measuring unit 48 provided in the MPU 26 in FIG. 1 measures and records a vibratory environment in the measurement table 52 in FIG. 3.

In FIG. 3, the measurement table 52 records therein a comparison result between the predetermined threshold value and the positional deviation amount of the head relative to the track center obtained by reading each servo information in the servo area 54-1 to 54-n (not shown) of the track which is presently followed and controlled by the head 22-1 in FIG. 2 as a measured value of the vibratory environment. This comparison result records a bit “1” when the positional deviation amount of the head exceeds the threshold value, and records a bit “0” on when it is less than the threshold value. Further, the measurement table 52 records therein data 55-1 for present rotation which records therein a comparison result between the threshold value and the positional deviation amount obtained from “n” items of servo information for one rotation of the disk with a present pointer P1 as a starting point, and data 55-2 for previous rotation which is a comparison result between the threshold value and the positional deviation amount obtained from “n” items of servo information with a pointer P2 before one rotation as a starting point. Thus, the bit “1” or “0” is stored as the comparison result between the detected positional deviation amount and the threshold value at the position indicated by the present pointer P1 each time the servo information is read, and the determination of the abnormal vibratory environment is used to determine an abnormal vibratory environment having high possibility of a write fault error by referring to the data 55-1 for present rotation with the present pointer P1 as the starting point and the data 55-2 for previous rotation with the pointer P2 before one rotation as the starting point. Here, the write fault error is an error which masks a circuit such that only the write operation cannot be performed when the deviation amount of the head relative to the track center exceeds the predetermined threshold value during the track following control of the head, and occurs only when the write operation is performed in this masked stated. Referring to FIG. 1 again, the vibration countermeasure processing unit 50 provided in the MPU 26 disables the write cache control unit 46 when an abnormal vibratory environment having a high possibility of failing the writing based on the write command from the host for the disk medium 20 is determined from the measured vibratory environment by the vibratory environment measuring unit 48, that is, the measurement contents of the measurement table 52 in the memory 30. That is, in the use state of the magnetic disk apparatus 10, the vibration countermeasure processing unit 50 provides a function of previously determining from the measurement result by the vibratory environment measuring unit 48 whether it is in an abnormal vibratory environment under which a write fault error is easily caused, and previously disabling the control function of the write cache control unit 46 when an abnormal vibratory environment is determined. Even after the abnormal vibratory environment is determined to disable the write cache control unit 46, the vibration countermeasure processing unit 50 determines the measurement result by the vibratory environment measuring unit 48, and releases the disabling of the write cache control unit 46 when the abnormal vibratory environment is not determined. Here, a determination condition and a release condition of the abnormal vibratory environment using the measurement result of the measurement table 52 by the vibration countermeasure processing unit 50 are as follows, for example. (1) The determination condition of the abnormal vibratory environment is that in the measurement table 52 of FIG. 3, the number of times at which the deviation amount of the head exceeds the threshold value is one or more times per rotation and continues for two rotations or more. (2) The release condition of the abnormal vibratory environment is that the number of times at which the deviation amount of the head exceeds the threshold value is zero per rotation. Since the condition for determining the presence of the abnormal vibratory environment is to determine whether the magnetic disk apparatus 10 is placed in an environment under which a write fault error is easily caused, the conditions are not limited to the above (1) and (2) and different variations can be set as needed. For the vibration countermeasure processing unit 50 provided in the MPU 26, when an abnormal vibratory environment is determined to disable the write cache control unit 46, if write cache data to be written back on the disk medium remains in the buffer memory 38, since the data cannot be written in the disk apparatus under the abnormal vibratory environment because a write fault error would occur, there is provided the temporary storage area for temporarily storing the write cache data in the buffer memory 38 on the disk medium 20 and the write cache data is stored therein. This temporary storage area for the write cache data may be provided in, for example, the nonvolatile memory 32 other than the disk medium 20.

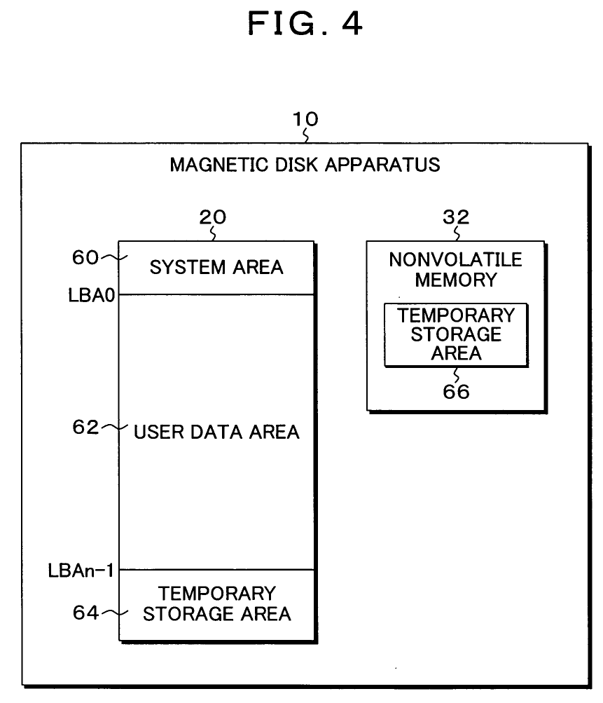

FIG. 4 is an explanatory diagram of the layout of the temporary storage area in the magnetic disk apparatus 10 according to the present invention. In FIG. 4, a user data area 62 is arranged between logical block addresses LBA0 to LBAn-1 on the disk medium 20 in the magnetic disk apparatus 10, and the user data area 62 is an area which the OS of the host can access. On the contrary, for example, a system area 60 is arranged before the logical block address LBA0. The system area 60 stores therein various information required for controlling the magnetic disk apparatus 10 such as positional information on a fault sector on the disk medium 20. Additionally, in the present invention, there is arranged at the last portion of the user data area 62 the temporary storage area 64 for storing therein the write cache data remaining in the buffer memory 38 when the control function of the write cache control unit 46 is disabled by the determination of the abnormal vibratory environment. Further, there may be provided the temporary storage area 66 for temporarily storing the write cache data in the nonvolatile memory 32 as needed.

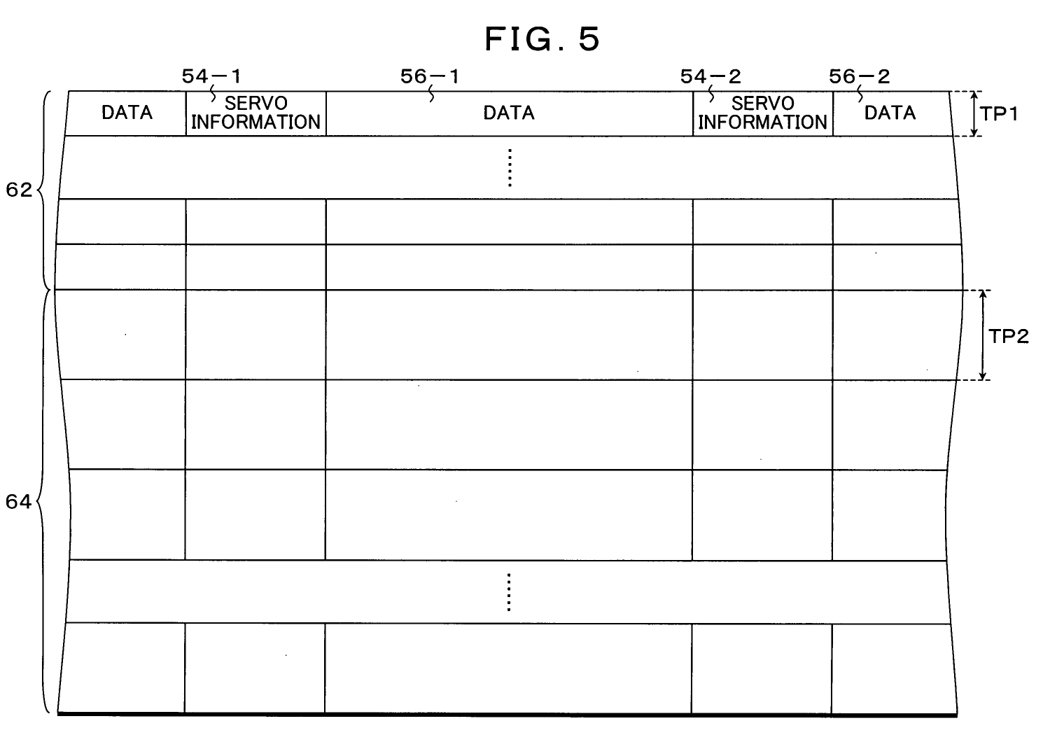

FIG. 5 shows a track of the temporary storage area 64 provided on the disk medium 20 of FIG. 4 with a track of the adjacent user data area 62. In FIG. 5, while the track of the user data area 62 has a track width TP1, the track of the temporary storage area 64 is formatted to have a track width TP2 which is, for example, 1.1 times to three times of the track width TP1 of the user data area 62, specifically twice in terms of the format efficiency. In this manner, the track width TP2 of the temporary storage area 64 is increased to, for example, twice the normal track width TP1 of the user data area 62, if the head is deviated from the tack center due to an external vibration in the state where the abnormal vibratory environment is determined, since the track width TP2 is sufficiently large, the writing can be normally performed on the track even when the head is largely deviated. In this manner, the temporary storage area 64 having the large track width assumes the threshold value for determining a write fault error when the deviation amount of the head relative to the track center is large as a larger threshold value for the user data area 62, thereby setting a condition under which the write fault error does not easily occur for the temporary storage area 64 even due to a vibration. Thus, it is possible to write the cache write data on the track in the temporary storage area 64 without performing the mask processing for prohibiting the write operation by the determination of the write fault error even if an external vibration is applied. On the other hand, for the temporary storage area 66 provided in the nonvolatile memory 32, it is possible to write the write cache data in the temporary storage area 66 irrespective of a vibration of the abnormal vibratory environment. Furthermore, in the state where the cache write data is written and temporarily stored in the temporary storage area 64 on the disk medium 20 or in the temporary storage area 66 in the nonvolatile memory 32 in FIG. 4, the control function of the write cache control unit 46 is disabled. Therefore, the write data received later is not written in the temporary storage area 64, 66. Thus, the capacity of the temporary storage area 64, 66 has only to guarantee the capacity capable of storing the cache data remaining in the buffer memory 38 when the write cache control unit 46 is disabled. The write data stored in the temporary storage area 64 or 66 is written back to the original position as the target sector of the target track based on the write command in the user data area 62 on the disk medium 20 when it is determined that the abnormal vibratory environment is eliminated. Further, the vibration countermeasure processing unit 50 in FIG. 1 performs the vibration countermeasure processing of storing not only the write data for the user data storage area 62 on the disk medium 20 but also the writing of the system information for the system area 60 in the temporary storage area 64 or 66 when the abnormal vibratory environment is determined, and writing back the same into the system area 60 after the abnormal vibratory environment is eliminated. That is, the magnetic disk apparatus 10 may write the information on the control of the apparatus in the system area 60 as the system information even under the user's use environment based on the access from the host. For example, when an abnormal vibratory environment is determined to disable the control function of the write cache control unit 46, the writing processing on the disk medium is performed in response to the write command without storing the write data in the buffer memory 38, and when the deviation amount of the head due to the vibration exceeds the threshold value in this case, the circuit is masked such that only the write operation cannot be performed, and a write fault error occurs when the write operation is performed in the masked state of the circuit. The magnetic disk apparatus performs the retry operation at predetermined times for this write fault error, and performs the alternating processing caused by the write fault when the retry operation fails. When the alternating processing caused by the write fault is performed, an address of the alternating destination needs to be recorded and stored in the system area 60. However, the writing may not be performed on the system area 60 due to an external vibration in the state where the abnormal vibratory environment is determined. In the present invention, the system information is written and stored in the temporary storage area 64 or 66 in response to a request of writing the system information in the system area 60 in the state where the abnormal vibratory environment is determined, and the system information stored in the temporary storage area 64 or 66 is written back to the original position in the system area 60 after it is determined that the abnormal vibratory environment is eliminated. The processing function by the vibration countermeasure processing unit 50 provided in the MPU 26 can designate the operational function from the host similarly as in the write cache control unit 46, and performs the processing operation as the vibration countermeasure processing unit 50 only when receiving the designation from the host. Naturally, the magnetic disk apparatus 10 may fixedly perform the function as the vibration countermeasure processing unit 50 irrespective of the designation from the host.

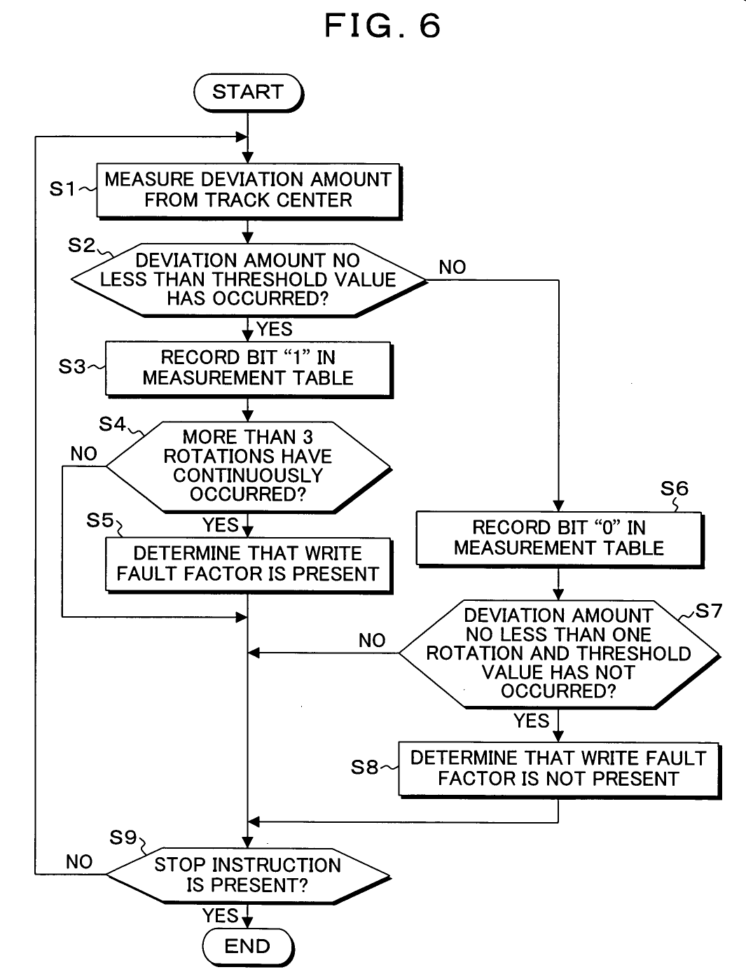

FIG. 6 is a flowchart of a measuring processing by the vibratory environment measuring unit 48 provided in the MPU 26 in FIG. 1 and an abnormal vibratory environment determining processing in the vibration countermeasure processing unit 50. The processings in FIG. 6 are performed each time the servo information in the servo area 54-1 to 54-n on the track is read by the head 22-1 as shown in FIG. 2. In FIG. 6, at first in step Si, the deviation amount of the head relative to the track center is measured based on the servo information, in step S2 it is determined whether the deviation amount exceeds the threshold value, and when the deviation amount is no less than the threshold value, in step S3 the bit “1” is recorded in the measurement table 52 as shown in FIG. 3, and when the deviation amount is less than the threshold value, in step S4 the bit “0” is recorded in the measurement table 52 in FIG. 3. In step S4, when the deviation amount no less than the threshold value occurs for two rotations or more in a row back from the recording position at the present time, that is, when at least one bit “1” is recorded in the data 55-1 for present rotation and the data 55-2 for previous rotation in FIG. 3, respectively, the processing proceeds to step S5, where it is determined that a write fault factor is present. On the other hand, in step S6, when the bit “0” is recorded in the measurement table based on the determination result of the deviation amount less than the threshold value in step S2, it is determined that the deviation amount no less than the threshold value does not occur during one rotation from the present recording position in step S7, that is, that the bit “1” is not recorded, and the processing proceeds to step S8, where it is determined that a write fault factor is not present. The processings from steps S1 to S8 are repeated each time the servo information is read until a stop instruction is issued in step S9. In the processing in FIG. 6, though the recording result of the presence of the deviation amount no less than the threshold value is determined on the recorded data of the past recording position before two rotations or one rotation with the point when the servo information was read as the starting point, whether the deviation amount no less than the threshold value occurred may be determined on the recording range for each rotation with the index of the servo information as the starting point as the recording range indicating the deviation amount no less than the threshold value for one rotation.

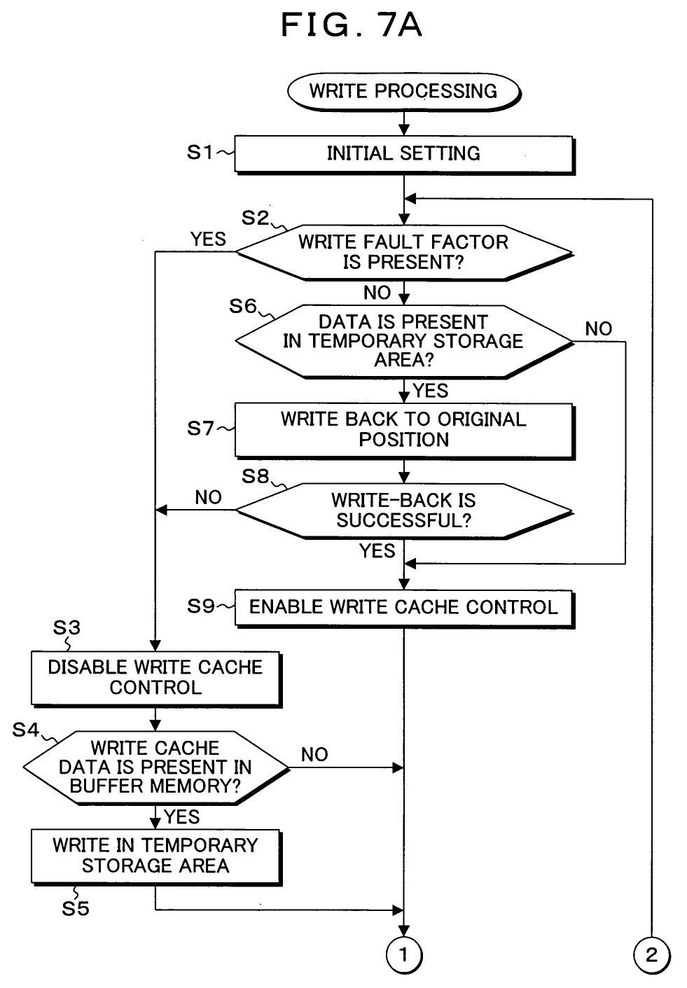

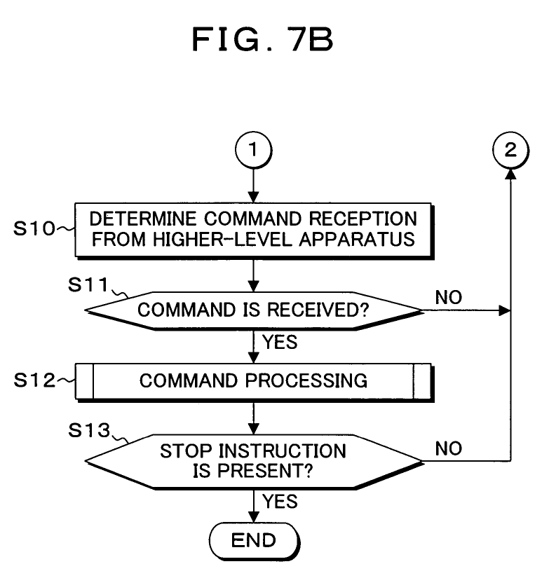

FIGS. 7A and 7B are flowcharts of a control processing according to the present invention using the processing function of the vibration countermeasure processing unit 50 in FIG. 1. In FIGS. 7A and 7B, when a power supply of the magnetic disk apparatus 10 is turned on, in step S1 an initial setting is performed so that a processing of a command from the host enters enable. Subsequently, in step S2 the determination result of FIG. 6 is referred to and it is determined whether a write fault factor is present, that is, whether there is an abnormal vibratory environment, and when the write fault factor is present, the processing proceeds to step S3, where it is determined that there is the abnormal vibratory environment and the control function of the write cache control unit 46 is disabled. Subsequently, in step S4 it is checked whether the write cache data received so far remains on the buffer memory 38, and when the write cache data remains, the processing proceeds to step S5, where the write cache data is written and stored in the temporary storage area 64 on the disk medium 20 shown in FIG. 4, for example. On the other hand, when it is determined in step S2 that the write fault factor is not present and that there is no abnormal vibratory environment, the processing proceeds to step S6, where it is checked whether data is present in the temporary storage area 64 on the disk medium 20 in FIG. 3, for example. When data is present in the temporary storage area, in step S7 the data is written back to the original position as the target sector of the target track based on the write command in the user data area 62 on the disk medium 20. Subsequently, in step S8 it is checked whether the writing-back is successful, and when the writing-back is successful, in step S9 the write cache control unit 46 is enabled and the processing proceeds to the next processing. When the writing-back fails in step S8, at this time, it is determined that the write fault factor, that is, the abnormal vibratory environment is present, and the processing proceeds to step S3, where the write cache control is disabled. When the above processings are terminated, in step S10 it is determined that the command has been received from the higher-level apparatus, and in step S11 when the command reception is determined, the processing proceeds to step S12, where the command processing is performed. This command processing is to read out read data from the disk medium and respond to the higher-level apparatus for a read command, or to perform writing control depending on whether the write cache control is disabled or enabled for a write command. The processings from steps S2 to S12 are repeated until a step instruction is issued in step S13.

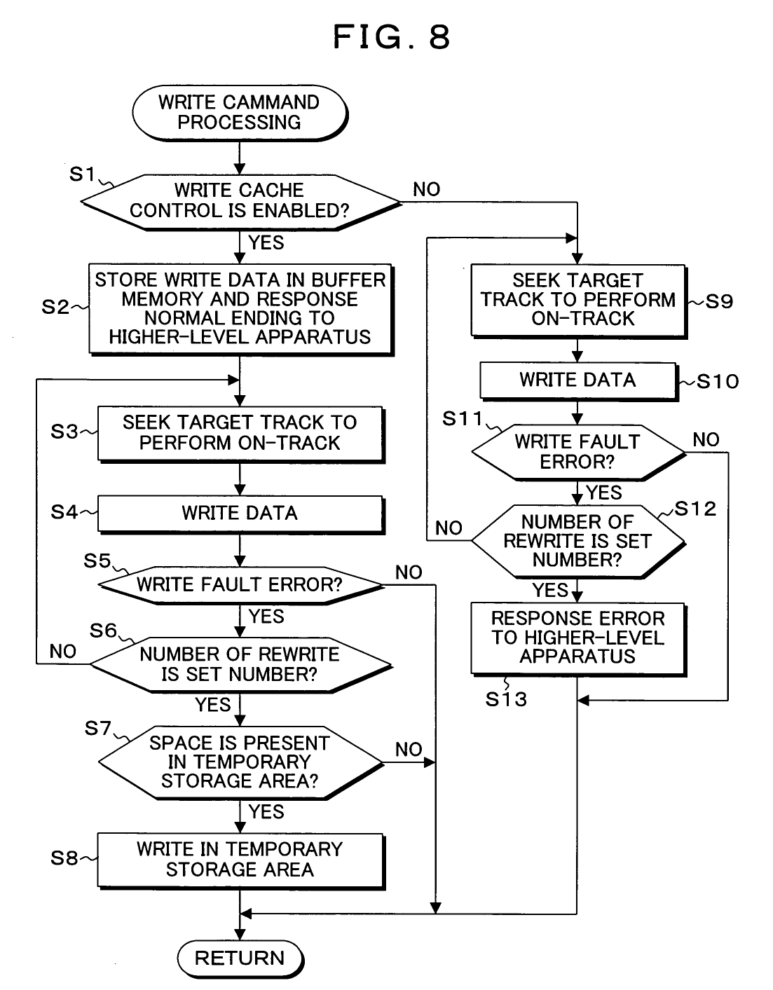

FIG. 8 is a flowchart of the write command processing of executing the write command in step S12 in FIGS. 7A and 7B. In FIG. 8, at first in step S1 it is checked whether the write cache control is enabled, and when it is enabled, the processing proceeds to step S2, where the write data is stored in the buffer memory 38 to respond the normal ending of the command to the higher-level apparatus. Subsequently, in step S3 seek control on the target track is performed based on the write command to perform on-track, and in step S4 the data in the buffer memory 38 is written on the disk medium. Subsequently, in step S5 the presence of a write fault error is checked, and when a write fault error is not present, a series of processings is terminated and the processing returns to the main routine in FIGS. 7A and 7B. When a write fault error is determined in step S5, in step S6 the seeking and the data writing from step S3 are repeated until the number of times of retry reaches the set number of times. At this time, when the write fault error occurs in the state where the abnormal vibratory environment may be determined due to an external vibration, the write fault error may still occur even when the number of times of retry reaches the set number of times. When the number of times of retry reaches the set number of times, the processing proceeds to step S7, since writing cannot be performed in the disk apparatus in this state, it is checked whether a apace is present in the temporary storage area, and if a space is present, in step S8 the cache data in the buffer memory 38 is written in the temporary storage area to normally terminate the command, and the processing returns to the main routine in FIGS. 7A and 7B. On the other hand, when it is determined in step S1 that the cache control is disabled, in step S9 the target track is sought based on the write command to perform on-track, and in step S10 the write data is written. Subsequently, in step S11 the presence of the write fault error is checked, and when the write fault error is not present, the write command processing is normally terminated and the processing returns to the main routine in FIGS. 7A and 7B. However, in the state where the write cache control is disabled, since there is an abnormal vibratory environment where a write fault error is easily caused, in step S11 it is likely that a write fault error occurs, and when a write fault error occurs, in step S12 a retry processing of seeking on the target track from step S9 to perform on-track and then writing data is performed until the number of times of retry reaches the set number of times. However, when the write fault error is not eliminated even by the retry processing at the set number of times and the writing fails, in step S13 the error is responded to the higher-level apparatus to terminate the writing processing and the processing returns to the main routine in FIGS. 7A and 7B. When the writing fails and the error can be responded to the higher-level apparatus in step S13, the higher-level apparatus which receives the error response performs the retry processing to reissue a write command, and since the write data remains in the higher-level apparatus even if the write data is lost from the magnetic disk apparatus due to the error, the user data will not be lost and the write data which has been erroneously terminated can be rewritten later by the retry of the higher-level apparatus.

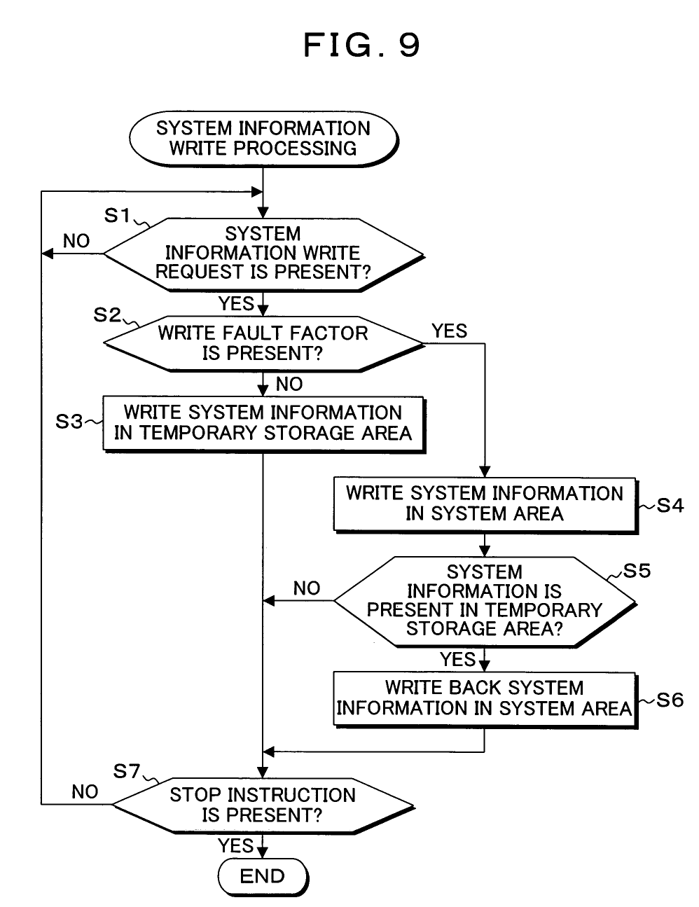

FIG. 9 is a flowchart of a system information write processing according to the present invention. In FIG. 9, when a request of writing system information is determined in step S1, the processing proceeds to step S2, where it is checked whether there is a write fault factor, that is, an abnormal vibratory environment, and when a write fault factor is present, the processing proceeds to step S3, where the system information is written and stored in the temporary storage area 64 on the disk medium 20 of FIG. 4, for example. On the other hand, in step S2, when a write fault factor is not eliminated, that is, when there is no abnormal vibratory environment, the processing proceeds to step S4, where the system information is normally written in the system area 60. Subsequently, in step S5 it is checked whether the system information is present in the temporary storage area, and when the system information is present, in step S6 the system information is written in the original system area. The processings from steps S1 to S6 are repeated until a stop instruction is issued in step S7. The present invention provides a program executed in the MPU 26 provided in the magnetic disk apparatus 10 in FIG. 1, and this program has the contents in the flowcharts shown in FIG. 6, FIG. 7A, FIG. 7B, FIG. 8 and FIG. 9. Though the above embodiments exemplify the magnetic disk apparatus, the present invention can be applied to a storage apparatus in an optical disk apparatus, a magnetooptical disk apparatus or the like. Further, the present invention includes appropriate modifications without losing objects and advantages thereof, and is not limited by the numerical values shown in the above embodiments.

What is claimed is:

1. A storage apparatus for writing data on a storage medium based on a write command from a higher-level apparatus, comprising:
a write cache control unit for storing data in a buffer in response to a write command from the higher-level apparatus to respond a normal ending of the command, and then writing the data in the buffer on the storage medium;
a vibratory environment measuring unit for measuring a vibratory environment of the apparatus; and
a vibration countermeasure processing unit for, when an abnormal vibratory environment under which writing on the storage medium likely fails is determined from a measured vibratory environment by the vibratory environment measuring unit, disabling the write cache control unit.

2. The storage apparatus according to claim 1, wherein after the write cache control unit is disabled, the vibration countermeasure processing unit releases the disabling of the write cache control unit when the abnormal vibratory environment is not determined.

3. The storage apparatus according to claim 1, wherein the vibratory environment measuring unit records a comparison result between a predetermined threshold value and the deviation amount of a head position relative to a track center position detected during track following control of a head,
when the number of times at which the head deviation amount recorded by the vibratory environment measuring unit exceeds the threshold value is the predetermined number of times or more per rotation and continues for several rotations, the vibration countermeasure processing unit determines the abnormal vibratory environment and disables the write cache control unit, and
after the write cache control unit is disabled, releases the disabling of the write cache control unit when the number of times at which the head deviation amount recorded by the vibratory environment measuring unit exceeds the threshold value does not exceed the predetermined threshold value per rotation.

4. The storage apparatus according to claim 1, wherein when the write cache control unit is disabled, if write data to be written back on the storage medium remains in the buffer, the vibration countermeasure processing unit stores the write data in a temporary storage area, and writes back the data stored in the temporary storage area on a storage medium in a state where the disabling of the write cache control unit is released.

5. The storage apparatus according to claim 1, wherein when the abnormal vibratory environment is determined in writing data in a system area on the storage medium, the vibration countermeasure processing unit stores the data in a temporary storage area, and writes back the data in the system area on the storage medium from the temporary storage area after the abnormal vibratory environment is not determined.

6. The storage apparatus according to claim 4, wherein the temporary storage area is provided on the storage medium, and the temporary storage area on the storage medium sets a track width to be wider for a normal storage area.

7. The storage apparatus according to claim 4, wherein the temporary storage area is provided in a nonvolatile memory in the storage apparatus.

8. A method for controlling a storage apparatus for writing data on a storage medium based on a write command from a higher-level apparatus, comprising:
a write cache control step for storing data in a buffer in response to a write command from the higher-level apparatus to respond a normal ending of the command, and then writing the data in the buffer on the storage medium;
a vibratory environment measuring step for measuring a vibratory environment of the apparatus; and
a vibration countermeasure processing step for, when an abnormal vibratory environment under which writing on the storage medium likely fails is determined from a measured vibratory environment by the vibratory environment measuring step, disabling the write cache control step.

9. The method for controlling a storage apparatus according to claim 8, wherein after the write cache control step is disabled, the vibration countermeasure processing step releases the disabling of the write cache control step when the abnormal vibratory environment is not determined.

10. The method for controlling a storage apparatus according to claim 8, wherein the vibratory environment measuring step records a comparison result between a predetermined threshold value and the deviation amount of a head position relative to a track center position detected during track following control of a head,
when the number of times at which the head deviation amount recorded by the vibratory environment measuring step exceeds the threshold value is the predetermined number of times or more per rotation and continues for several rotations, the vibration countermeasure processing step determines the abnormal vibratory environment and disables the write cache control step, and
after the write cache control step is disabled, releases the disabling of the write cache control step when the number of times at which the head deviation amount recorded by the vibratory environment measuring step exceeds the threshold value does not exceed the predetermined threshold value per rotation.

11. The method for controlling a storage apparatus according to claim 8, wherein when the write cache control step is disabled, if write data to be written back on the storage medium remains in the buffer, the vibration countermeasure processing step stores the write data in a temporary storage area, and writes back the data stored in the temporary storage area on a storage medium in a state where the disabling of the write cache control step is released.

12. The method for controlling a storage apparatus according to claim 8, wherein when the abnormal vibratory environment is determined in writing data in a system area on the storage medium, the vibration countermeasure processing step stores the data in a temporary storage area, and writes back the data in the system area on the storage medium from the temporary storage area after the abnormal vibratory environment is not determined.

13. The method for controlling a storage apparatus according to claim 11, wherein the temporary storage area is provided on the storage medium, and the temporary storage area on the storage medium sets a track width to be wider for a normal storage area.

14. The method for controlling a storage apparatus according to claim 11, wherein the temporary storage area is provided in a nonvolatile memory in the storage apparatus.

15. A program for writing data on a storage medium based on a write command from a higher-level apparatus, wherein said program allows a computer to execute:
a write cache control step for storing data in a buffer in response to a write command from the higher-level apparatus to respond a normal ending of the command, and then writing the data in the buffer on the storage medium;
a vibratory environment measuring step for measuring a vibratory environment of the apparatus; and
a vibration countermeasure processing step for, when an abnormal vibratory environment under which writing on the storage medium likely fails is determined from a measured vibratory environment by the vibratory environment measuring step, disabling the write cache control step.

16. The program according to claim 15, wherein after the write cache control step is disabled, the vibration countermeasure processing step releases the disabling of the write cache control step when the abnormal vibratory environment is not determined.

17. The program according to claim 15, wherein the vibratory environment measuring step records a comparison result between a predetermined threshold value and the deviation amount of a head position relative to a track center position detected during track following control of a head,
when the number of times at which the head deviation amount recorded by the vibratory environment measuring step exceeds the threshold value is the predetermined number of times or more per rotation and continues for several rotations, the vibration countermeasure processing step determines the abnormal vibratory environment and disables the write cache control step, and
after the write cache control step is disabled, releases the disabling of the write cache control step when the number of times at which the head deviation amount recorded by the vibratory environment measuring step exceeds the threshold value does not exceed the predetermined threshold value per rotation.

18. The program according to claim 15, wherein when the write cache control step is disabled, if write data to be written back on the storage medium remains in the buffer, the vibration countermeasure processing step stores the write data in a temporary storage area, and writes back the data stored in the temporary storage area on a storage medium in a state where the disabling of the write cache control step is released.

19. The program according to claim 15, wherein when the abnormal vibratory environment is determined in writing data in a system area on the storage medium, the vibration countermeasure processing step stores the data in a temporary storage area, and writes back the data in the system area on the storage medium from the temporary storage area after the abnormal vibratory environment is not determined.

20. The program according to claim 18, wherein the temporary storage area is provided on the storage medium, and the temporary storage area on the storage medium sets a track width to be wider for a normal storage area.
